(19) United States
(12) Patent Application Publication
(10) Pub. No.: US 2010/0251621 A1
(43) Pub. Date: Oct. 7, 2010

(54) DOOR SEAL CLIP

(75) Inventor: Joseph A. Donoho, Springfield, TN (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 12/749,992

(22) Filed: Mar. 30, 2010

Related U.S. Application Data
(60) Provisional application No. 61/165,684, filed on Apr. 1, 2009.

(51) Int. Cl. E06B 7/16; A44B 99/00

(52) U.S. Cl. 49/493.1; 24/457; 24/458

(57) ABSTRACT

A door seal assembly includes a gasket and at least one door seal clip. The gasket includes an inner core and an outer jacket. The at least one door seal clip is formed from a wire segment and is adapted to be mounted to the gasket. The door seal clip includes an attachment portion and a base portion. The attachment portion is formed as a first loop extending along a longitudinal axis of the door seal clip. The attachment portion is capable of undergoing elastic deformation transversely about the longitudinal axis. The base portion is formed as a second loop oriented in a substantially perpendicular manner about the first loop. The base portion is adapted to be mounted between the inner core and the outer jacket.

### CROSS-REFERENCE TO RELATED APPLICATIONS

This application claims the benefit of U.S. Provisional Application No. 61/165,684, filed Apr. 1, 2009, the entire disclosure of which is hereby incorporated herein by reference.

### TECHNICAL FIELD

The disclosure relates to clips configured to couple gaskets to mounting surfaces and, more particularly, clips configured to couple gaskets for sealing gaps between a door and an enclosed structure.

### BACKGROUND

Household appliance doors typically include a gasket provided around an interior periphery of the door to facilitate sealing of the appliance cavity. One type of gasket that can be used, and is commonly used in cooking ovens, is a tubular gasket comprised of thermally insulating yarn supported by an inner wire core.

Tubular gaskets such as these have been used for seals for oven doors for many years. These articles are typically made from a combination of an inner tubular support member formed of knitted wire and an outer tubular member made either by braiding, knitting or weaving an insulating material such as fiberglass yarn. Such structures have proven to be durable at the high temperatures used in self cleaning ovens and provide a good seal despite repeated openings and closures of the oven door over many years of use.

Methods of attaching a tubular gasket to an oven or oven door surface have typically comprised providing a retaining member which extends along the gasket and locking the retaining member between sheet metal pieces of the oven or by providing clamps at spaced locations around the periphery of the gasket.

### SUMMARY

In one example aspect, a door seal clip is formed from a wire segment and includes an attachment portion and a base portion. The attachment portion includes a tip and the base portion is disposed about the attachment portion so as to be opposite the tip. The base portion extends transversely about a longitudinal axis of the door seal clip. The attachment portion is capable of undergoing elastic deformation transversely about the longitudinal axis. The base portion includes a first end of the wire segment and includes a protrusion projecting away from a plane in which the base portion lies and toward an upper side of the plane on which the attachment portion is disposed.

In another example aspect, a door seal clip is formed from a wire segment and includes a first loop and a second loop. The first loop extends along a longitudinal axis of the door seal clip. The first loop is capable of undergoing elastic deformation transversely about the longitudinal axis. The second loop lies in a plane so as to be oriented in a substantially perpendicular manner about the first loop and substantially delineates a contour of a closed, two-dimensional figure. The second loop includes an end of the wire segment and the end strays transversely outward from the contour of the figure.

In yet another example aspect, a door seal assembly includes a gasket and at least one door seal clip. The gasket includes an inner core and an outer jacket and the door seal clip is formed from a wire segment and adapted to be mounted to the gasket. The door seal clip includes an attachment portion and a base portion. The attachment portion is formed as a first loop extending along a longitudinal axis of the door seal clip. The attachment portion is capable of undergoing elastic deformation transversely about the longitudinal axis. The base portion is formed as a second loop oriented in a substantially perpendicular manner about the first loop and is adapted to be mounted between the inner core and the outer jacket.

### BRIEF DESCRIPTION OF THE DRAWINGS

These and other aspects are better understood when the following detailed description is read with reference to the accompanying drawings, in which:

FIG. 1 is a perspective view of a first embodiment of a door seal clip;

FIG. 2 is a top view of the first embodiment of the door seal clip;

FIG. 3 is a perspective view of a second embodiment of the door seal clip;

FIG. 4 is a side view of the second embodiment of the door seal clip;

FIG. 5A is a cross-sectional view of a gasket with a base portion of a first embodiment of the door seal clip located between an outer jacket and an inner core;

FIG. 5B is a cross-sectional view of the gasket with the base portion of a second embodiment of the door seal clip located between the outer jacket and the inner core; and

FIG. 6 is a view of a home appliance on which a door seal assembly can be implemented.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

Referring now to FIG. 6, a structure 10, such as a home appliance, with an enclosure 12, such as an oven cavity, on which a door seal assembly 14 can be implemented, is illustrated. However, the door seal assembly 14 may be implemented on a variety of structures, such as a dryer, a furnace, a dishwasher, or the like. The door seal assembly 14 is mounted on the door 16 of the structure in order to provide sealing of the gaps between the door 16 and the enclosure 12 when the door 16 is closed and insulate the conditions inside the enclosure 12 from conditions of the surrounding environment and vice versa.

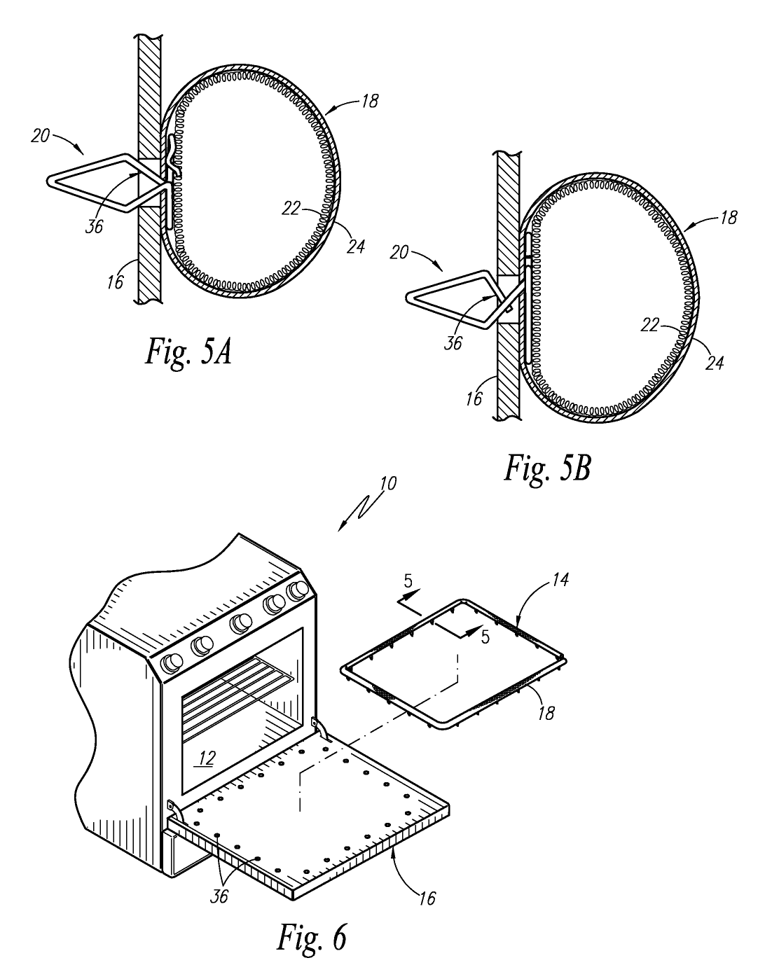

As shown in FIGS. 5A and 5B, one embodiment of the door seal assembly 14 may include a gasket 18 and a plurality of door seal clips 20. The gasket 18 may include an inner core 22 and an outer jacket 24. The inner core 22 may provide a tubular framework for the gasket 18 and may be formed of stranded material arranged in a network such as an array of intermeshed loops. The inner core 22 may be made of any material capable of providing a sufficient degree of rigidity, flexibility and thermal resistance and may be metallic, for example. The outer jacket 24 may be dimensioned to surround the inner core closely in a tubular fashion and may be made of material that provides a sufficient degree of thermal resistance and thermal insulation. For example, the outer jacket 24 may be made of fabric that is woven to fit around the inner core 22. However, the gasket 18 may be embodied in alternative embodiments and may be formed as a single tubular structure or a tubular structure with three or more layers.

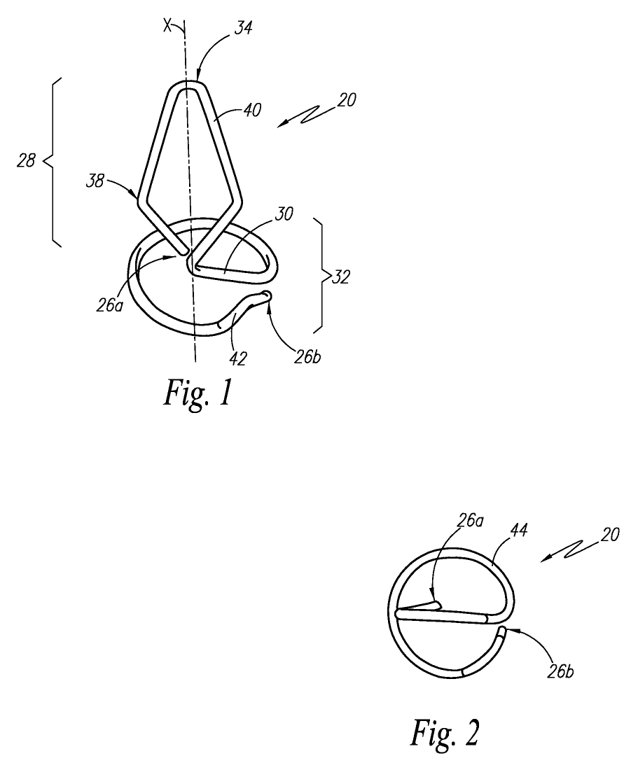

As shown in FIGS. 5A and 5B, the clips 20 allow the gasket 18 to be secured to the door 16 and are adapted to be secured to the gasket 18. As shown in FIGS. 1-4, the clip 20 can be formed from a single wire segment. The clip 20 can include an attachment portion 28, a transition portion 30 and a base portion 32. The attachment portion 28 includes a pointed tip 34 that can be inserted into an aperture 36 provided on an inner side of the door 16. The attachment portion 28 may be shaped to gradually widen away from the tip 34 and facilitate such insertion. The arrangement of such apertures 36 determines the shape of the gasket 18 on the door 16 and may be in a rectangular configuration (FIG. 6). The attachment portion 28 may be elongate and extend along a longitudinal axis X. The tip 34 and the base portion 32 may be located at opposite ends of the clip 20 while the transition portion 30 joins the attachment portion 28 to the base portion 32. In the illustrated embodiments, a second end 26a of the wire segment is part of the attachment portion 28 and a first end 26b of the wire segment is part of the base portion 32 although this may vary in alternate embodiments. The first end 26b may be adapted to engage the gasket 18 or the outer jacket 24.

The attachment portion 28 enables the gasket 18 to be secured to the door 16 because the attachment portion 28 is capable of undergoing elastic deformation transversely about the longitudinal axis X. While the dimension of the widest part 38 of the attachment portion 28 in a normal, non-deformed state is larger than the diameter of the aperture 36 on the door 16, the attachment portion 28 is able to flex or deflect transversely and decrease in width during insertion into the aperture 36. After the attachment portion 28 is sufficiently inserted in the aperture 36, the attachment portion 28 may return completely or partially to its original shape so that the widest part 38 prevents the clip 20 from being disengaged from the aperture 36.

In the present embodiment, such a feature is enabled by forming the attachment portion 28 in a kite-shaped, first loop 40 although the attachment portion 28 can also be embodied in a different type of quadrilateral or polygonal loop or even two-dimensional or other multi-dimensional shapes that may or may not form a loop. While the first loop 40 is substantially shaped in a closed, two-dimensional figure, other variations of the first loop 40 may include two-dimensional figures with one or more open edges, for example.

Moreover, in the present embodiment, the second end 26a and the first end 26b are adjacent the transition portion 30 although this may vary depending on how the attachment portion 28 and the base portion 32 are formed. The first loop 40 is formed such that the second end 26a does not encounter other parts of the attachment portion 28 during flexing or deflecting and such that the movement of the attachment portion 28 is not restricted. For example, the second end 26a is not aligned with but is rather offset from the part of the attachment portion 28 that is adjacent the second end 26a, as shown in FIGS. 2 and 4.

As shown in FIGS. 1-4, the base portion 32 extends transversely about the longitudinal axis X along which the attachment portion 28 extends and a plane in which the base portion 32 lies is oriented in a substantially perpendicular manner about the longitudinal axis X. The base portion 32 may be adapted to be entirely located or sandwiched between the layer of the outer jacket 24 and the layer of the inner core 22 after the clip 20 is mounted to the gasket 18 although this may be different in alternatively embodied gaskets. The base portion 32 includes a feature that is provided to facilitate engagement of the gasket 18 or outer jacket 24 by the first end 26b and that may be embodied in a variety of manners.

The base portion 32 may be formed in a second loop 44 although one or more loops or other two or three-dimensional shapes can also be formed. Similarly to the first loop 40, the second loop 44 may be substantially shaped in a closed, two-dimensional shape or a two-dimensional shape with one or more open edges. In a first embodiment shown in FIGS. 1-2, a second loop 44 of the base portion 32 has a substantially circular shape and the protrusion 42 projects upward away from the second loop 44 and outside of the plane in which the second loop 44 lies. Moreover, the protrusion 42 has a crest shape or an inverted ‘v’ configuration and may project upward, i.e., toward an upper side of the plane on which the attachment portion 28 is disposed. In case the base portion 32 includes the first end 26b of the wire segment, the protrusion 42 may be formed near the first end 26b of the wire segment. Despite the presence of the protrusion 42, the first end 26b partially delineates the shape of the figure defined by the second loop 44.

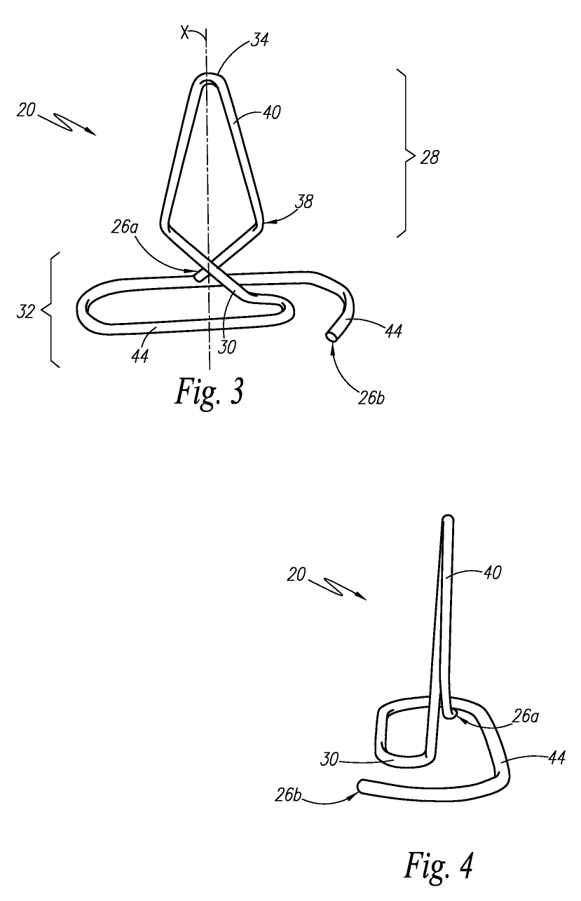

In a second embodiment shown in FIGS. 3-4, the second loop 44 has a substantially oval shape and the first end 26b strays transversely about the clip 20 away from a contour of the figure that is defined by the second loop 44. It must be noted that the protrusion 42 near the first end 26b can be formed for second loops 44 having a variety of shapes.

In order to secure the base portion 32 of the clip 20 between the outer jacket 24 and the inner core 22, the first end 26b of the base portion 32 is used to pierce through the fabric layer of the outer jacket 24 or an exterior of the gasket 18. In the first embodiment, piercing is facilitated because an assembly person, a machine or the like can press against the protrusion 42 causing the first end 26b to project onto a lower side of the plane in which the base portion 32 lies. In case of manual assembly, an assembler can hold the clip 20 by the attachment portion 28 using the index finger and the thumb such that the index finger touches the protrusion 42 in FIGS. 1-2. Thereafter, the assembler can slide the index finger toward the base portion 32 so as to press down on the protrusion 42 down such that the first end 26b becomes protruded on the lower side of the plane. In this way, penetration of the fabric layer of the outer jacket 24 or the exterior of the gasket 18 is accomplished more easily. In the second embodiment, piercing is facilitated because the first end 26b that strays away from the contour of the figure delineated by the second loop 44 can engage the outer jacket 24 or the gasket 18 more easily. The clip 20 is moved with respect to the gasket 18 such that the first end 26b approaches the exterior of the gasket 18 at an angle and can pierce through the exterior of the gasket 18 or the outer jacket 24.

Once the first end 26b pierces the exterior of the gasket 18 or the outer jacket 24, the clip 20 is rotated about the longitudinal axis X to insert the rest of the base portion 32 until the entire base portion 32 lies under the layer of the outer jacket 24 or the exterior of the gasket 18. In case of the first embodiment, once the base portion 32 is entirely located between the outer jacket 24 and the inner core 22 or underneath the exterior of the gasket 18, the first end 26b may engage the inner core 22 and further secure the clip 20 to the gasket 18 (FIG. 5). This may occur because, while the base portion 32 is mounted under the outer jacket 24, the outer jacket 24 may press down on the protrusion 42 and the first end 26b may remain projecting onto the lower side of the plane of the base portion 32 so as to interlock with a loop of the inner core 22 thereby preventing undesired movement or rotation of the clip 20. In case of the second embodiment, the oval shape of the base portion 32 reduces the likelihood of rotation while the base portion 32 is placed between the outer jacket 24 and the inner core 22 (FIG. 6).

It will be apparent to those skilled in the art that various modifications and variations can be made without departing from the spirit and scope of the claimed invention.

What is claimed is:

1. A door seal clip formed from a wire segment and including:
an attachment portion including a tip; and
a base portion disposed about the attachment portion so as to be opposite the tip, the base portion extending transversely about a longitudinal axis of the door seal clip, the attachment portion capable of undergoing elastic deformation transversely about the longitudinal axis, the base portion including a first end of the wire segment, the base portion including a protrusion projecting away from a plane in which the base portion lies and toward an upper side of the plane on which the attachment portion is disposed.

2. The door seal clip of claim 1, the door seal clip adapted to be mounted to a gasket, the protrusion adapted to be pressed so that the first end projects onto a lower side of the plane opposite the upper side thereby facilitating engagement of the gasket by the first end.

3. The door seal clip of claim 2, the protrusion formed near the first end.

4. The door seal clip of claim 1, the protrusion being crest-shaped.

5. The door seal clip of claim 1, the base portion oriented substantially perpendicular to the attachment portion.

6. The door seal clip of claim 1, the attachment portion forms a first loop substantially shaped in a closed, two-dimensional first figure.

7. The door seal clip of claim 6, the first figure being kite-shaped.

8. The door seal clip of claim 1, the base portion forms a second loop substantially shaped as a closed, two-dimensional second figure.

9. The door seal clip of claim 8, the second figure being circular.

10. The door seal clip of claim 1, the wire segment further including a second end, the attachment portion including the second end.

11. The door seal clip of claim 10, the base portion substantially shaped as a closed, two-dimensional second figure, the second end partially delineating the second figure.

12. The door seal clip of claim 1, further including a transition portion joining the attachment portion and the base portion.

13. The door seal clip of claim 1, the attachment portion adapted to secure the door seal clip to a door by inserting the tip into an aperture formed on the door.

14. A door seal clip formed from a wire segment and including:
a first loop extending along a longitudinal axis of the door seal clip, the first loop capable of undergoing elastic deformation transversely about the longitudinal axis; and
a second loop lying a plane so as to be oriented in a substantially perpendicular manner about the first loop, the second loop substantially delineating a contour of a closed, two-dimensional figure, the second loop including an end of the wire segment, the end straying transversely outward from the contour of the figure.

15. The door seal clip of claim 14, the figure is an oval.

16. A door seal assembly including:
a gasket including an inner core and an outer jacket; and
at least one door seal clip formed from a wire segment and adapted to be mounted to the gasket, the door seal clip including:
an attachment portion formed as a first loop extending along a longitudinal axis of the door seal clip, the attachment portion capable of undergoing elastic deformation transversely about the longitudinal axis; and
a base portion formed as a second loop oriented in a substantially perpendicular manner about the first loop, the base portion adapted to be mounted between the inner core and the outer jacket.

17. The door seal assembly of claim 16, the base portion including an end of the wire segment that is adapted to engage the outer jacket.

18. The door seal assembly of claim 17, the base portion including a protrusion projecting away from a plane in which the base portion lies and toward an upper side of the plane on which the attachment portion is disposed, the protrusion formed near the end of the wire segment.

19. The door seal assembly of claim 17, the second loop substantially delineating a contour of a closed, two-dimensional figure, the end straying outward from the contour of the closed figure.
